(19) United States
(12) Patent Application Publication
(10) Pub. No.: US 2013/0230928 A1
(43) Pub. Date: Sep. 5, 2013

(54) SENSOR MEMBRANES FOR REAGENT FREE IMAGING OF DISSOLVED FERROUS IRON CONCENTRATIONS

(71) Applicants: Qingzhi Zhu, East Setauket, NY (US); Robert Aller, Stony Brook, NY (US)

(72) Inventors: Qingzhi Zhu, East Setauket, NY (US); Robert Aller, Stony Brook, NY (US)

(21) Appl. No.: 13/785,637

(22) Filed: Mar. 5, 2013

Related U.S. Application Data
(60) Provisional application No. 61/606,764, filed on Mar. 5, 2012.

(51) Int. Cl. G01N 21/82; B05D 3/00

(52) U.S. Cl. CPC G01N 21/82; B05D 3/007
USPC 436/84; 422/82.05; 427/384; 427/377

(57) ABSTRACT

A method for measuring iron concentration that includes providing a sensor including a substrate, a ferrozine containing reagent, and a polymer covalently bonding the ferrozine containing reagent on the substrate. The sensor is inserted into an iron (Fe) containing sample. The ferrozine containing reagant reacts with iron (Fe) ions in the iron (Fe) containing sample. The optical properties of the sensor are measured after the ferrozine containing reagent reacts with the iron (Fe) ions in the iron (Fe) containing sample to determine the concentration of the iron (Fe) ions in the iron (Fe) containing sample.

### CROSS-REFERENCE TO RELATED APPLICATION

The present application claims benefit of U.S. Provisional Application No. 61/606,764, filed Mar. 5, 2012, the disclosure of which is incorporated herein by reference in its entirety.

### BACKGROUND

The present disclosure is related to structures and methods for measuring iron concentration.

Iron (Fe) is one of the key redox sensitive elements in marine sediment, and its distribution patterns reflect multiple biogeochemical reactions and processes in marine deposits, e.g., remineralization of organic matter, sulfur cycling, solute transport, sediment reworking and accumulation rates. Understanding the diagenetic behavior of iron (Fe) can therefore be essential to the study of marine sediment and seawater biogeochemistry. Because dissolved ferrous iron produced during iron (Fe) reduction can be rapidly oxidized to insoluble ferric oxides by oxygen, nitrate ions (NO₃⁻) and Mn-oxides in surficial sediment, intense iron (Fe) gradients, such as Fe²⁺ gradients, are typically found near the sediment-water interface of marine deposits underlying oxygenated waters. These Fe²⁺ gradients in sediment are often substantial, with changes of hundreds of micromolar (μM) of Fe²⁺ over millimeter to centimeter vertical scales, and can be strongly time-dependent in response to changes in water column oxygenation, organic matter inputs, and sedimentary dynamics.

Measurements of dissolved Fe²⁺ in sediment pore water are traditionally done by sectioning cores vertically over finite depth intervals, e.g., 0.5 cm-2 cm intervals, under an inert atmosphere, e.g., N₂, in the lab, separating pore water by centrifugation or compaction under pressure, filtering the expressed solution, acidifying and analyzing dissolved ion (Fe) (predominantly Fe²⁺) using AAS or spectrophotometric UV-VIS methods. The physical processing of the sediment cores can be arduous and time-consuming, and more importantly, it may disturb natural distributions. For example, Fe²⁺ may decrease due to exposure to oxygen during sampling, or it may increase if cores are not sampled sufficiently rapidly and become unnaturally anoxic in otherwise oxic regions. These traditional methods also usually provide only average vertical concentration profiles unless sediment is otherwise dissected.

Various methods of studying the distribution of dissolved iron and other trace metals in sediment at submillimeter scale have been proposed. One approach is DET (diffusive equilibrium in thin-films) or the related DGT (diffusive gradients in thin-films) technique, which use surfaces coated with polyacrylamide hydrogel or polyacrylamide layers with chelating resin to equilibrate with contacting sediment and to determine trace metal concentrations or potential metal concentrations and desorption sources. These methods can provide overall vertical concentration profiles and 2-D patterns of dissolved metal ions with spatial resolutions of 100 μm after the equilibrated gel layer is analyzed. A second way is using laser ablation ICP-MS to directly analyze 2-dimensional trace metal concentrations in small areas of the gel surface, e.g., 1 cm². These methods are powerful but are time-consuming and expensive, with potentially hundreds or even thousands of individual analyses required for constructing a 2-dimensional image.

### SUMMARY

In one aspect, the present disclosure provides an optical iron (Fe) sensor for measuring iron Fe²⁺ concentration, and revealing 2-dimensional distribution patterns of Fe²⁺ in iron containing samples, such as bioturbated muddy or sandy sediments. In one embodiment, the sensor for measuring iron concentration includes a substrate, a ferrozine containing reagent for detecting iron (Fe), and a polymer covalently bonding the ferrozine containing reagent to the substrate. In some embodiment, the substrate includes a membrane of poly(vinyl alcohol), poly(vinyl chloride), D4 polyurethane hydrogel or ethyl cellulose, and the ferrozine containing reagent may be 3-(2-pyridyl)-5,6-diphenyl-1,2,4-triazine-p,p′-disulfonic acid monosodium salt hydrate. The membrane of the substrate may have a surface area ranging from 1 cm² to 300 cm², and may have a thickness of 15 microns or less. The membrane of the substrate may be backed with a polyester sheet. In one embodiment, the polymer bonding the ferrozine containing reagent is poly(N-isopropylacrylamide). The covalent bonding of the polymer to the ferrozine containing reagent may be to a sulfonate group of the ferrozine containing reagent. In some embodiments, the concentration of ferrozine containing reagent that is present on the sensor ranges from 10 to 50 μg/cm².

In another aspect, a method is provided for making a sensor for measuring iron concentration. In one embodiment, the method includes reacting ferrozine (3-(2-pyridyl)-5,6-diphenyl-1,2,4-triazine-p,p′-disulfonic acid monosodium salt hydrate) with phosphorus pentachloride (PCl₅) to provide ferrozine sulfonyl chloride, reacting ferrozine sulfonyl chloride with unsaturated alkyl amine to provide ferrozine sulfonamide, and polymerizing a solution of the ferrozine sulfonamide and N-isopropylacrylamide onto a poly(vinyl alcohol) membrane surface, in which the poly(vinyl alcohol) membrane surface includes at least one unsaturated alkyl bond. The polymerization of the solution of the ferrozine sulfonamide and N-isopropylacrylamide onto the membrane surface provides a ferrozine containing reagent that is covalently bonded to the poly(vinyl alcohol) membrane surface. The ferrozine containing reagent reacts with iron (Fe²⁺) ions to form a ferrozine-Fe²⁺ complex. In one embodiment, the unsaturated alkyl amine is at least one compound that is selected from the group consisting of allylamine, methallylamine, 4-aminostyrene and vinylaniline

In one embodiment, the poly(vinyl alcohol) membrane of the sensor is provided by mixing poly(vinyl alcohol) in a water solution with glutaraldehyde (CH₂(CH₂CHO)₂), allylamine (C₃H₅NH₂), and hydrogen chloride (HCl). The ferrozine sulfonyl chloride that subsequently reacts with allylamine is extracted with anhydrous acetone from the product of a ferrozine (3-(2-pyridyl)-5,6-diphenyl-1,2,4-triazine-p,p′-disulfonic acid monosodium salt hydrate) and phosphorus pentachloride (PCl₅) reaction. The poly (N-isopropylacrylamide) is formed from monomer N-isoproplyacrylamide without crosslinker. The polymerizing is conducted in a nitrogen (N₂) atmosphere.

In another aspect, a method of measuring iron concentration is provided using a sensor having a ferrozine containing reagent present thereon. In one embodiment, the method for measuring iron concentration includes providing a sensor including a substrate, a ferrozine containing reagent, and a polymer covalently bonding the ferrozine containing reagent on the substrate. The sensor may be inserted into an iron containing sample, wherein the ferrozine containing reagent reacts with iron (Fe²⁺) ions in the iron containing sample. The optical properties of the sensor may be measured after the ferrozine containing reagent reacts with the iron (Fe²⁺) ions in the iron containing sample to determine the concentration of the iron (Fe²⁺) ions in the iron containing sample. In some embodiments, the substrate of the sensor may include a membrane of poly(vinyl alcohol), and the covalently bonding of ferrozine containing reagent to the membrane that is provided by the polymer may be through the sulfonate groups of the ferrozine containing reagent.

In some embodiments, the insertion of the sensor into the iron containing sample may include the formation of a ferrozine-Fe²⁺ complex on the membrane of the substrate. The iron containing sample may include a liquid solution of iron (Fe²⁺) ions, sediment containing iron or a combination thereof. The iron containing sample may have a pH ranging from 3.5 to 10.5. In some embodiments, after the sensor has been applied to the iron containing sample, the optical properties of the sensor may be measured by comparison of the sensor to a color chart, scanning the sensor with a flatbed optical scanner or hand held scanner and/or imaging the sensor with a digital (or CCD) camera. The optical properties of the sensor may be measured to determine the concentration of the iron (Fe²⁺) ions in the iron containing sample. In one embodiment, the concentration of the iron (Fe²⁺) ions in the iron containing sample may be measured by measuring an absorbance of a wavelength through the sensor and correlating the absorbance to a concentration of iron (Fe²⁺) ions in the ferrozine-Fe²⁺ complex on the membrane of the sensor. Correlating of the absorbance to the concentration of iron (Fe²⁺) ions may be through Beer-Lambert law. In one embodiment, there is a linear correlation between absorbance and the concentration of iron (Fe²⁺) ions in the ferrozine-Fe²⁺ complex on the membrane that is formed on the membrane of the substrate. In one embodiment, as the absorbance measured increases, the concentration of iron (Fe²⁺) ions in the ferrozine-Fe²⁺ complex increases.

The sensor having a ferrozine containing reagent present thereon has a maximum absorbance wavelength ranging from 550 nm to 570 nm. The concentration of the iron (Fe²⁺) ions measured by the sensor may be as great as 200 μM. The minimum concentration of iron (Fe²⁺) ions measured by the sensor may be as low as 4.5 μM. In some embodiments, when the iron containing sample is an earthly (e.g., mud, sand) sediment containing Fe²⁺ ions, the measurement of the concentration of iron (Fe²⁺) ions measured by the sensor may provide a 2-dimensional distribution pattern of the Fe²⁺ ions in the iron containing sample. The use of a transparent polymer carrier allows direct visual imaging of an environmental surface simultaneously with analysis of Fe²⁺.

### BRIEF DESCRIPTION OF THE DRAWINGS

The file of this patent contains at least one drawing executed in color. Copies of this patent with color drawing(s) will be provided by the Patent and Trademark Office upon request and payment of the necessary fee.

The following detailed description, given by way of example and not intended to limit the disclosure solely thereto, will best be appreciated in conjunction with the accompanying drawings, wherein like reference numerals denote like elements and parts, in which:

FIG. 1 is a perspective front view of one embodiment of a sensor for measuring iron concentration that includes a substrate, a ferrozine containing reagent for detecting iron (Fe²⁺) ions, and a polymer covalently bonding the ferrozine containing reagent to the substrate, in accordance with one embodiment of the present disclosure.

FIG. 2 is a perspective side view of the sensor depicted in FIG. 1.

FIG. 3 depicts the chemical structure of ferrozine prior being covalently bonded to the substrate of the sensor, in accordance with one embodiment of the present disclosure.

FIG. 4A is a plot of the absorbance spectra of an iron sensor including covalently immobilized ferrozine that has reacted with Fe²⁺ ions within an iron containing sample, in accordance with one embodiment of the present disclosure.

FIG. 4B is a plot of absorbance measured with an iron sensor including covalently immobilized ferrozine vs. iron containing samples within increasing Fe²⁺ concentration, in accordance with one embodiment of the present disclosure.

FIG. 5 is a plot of absorbance vs. reaction time for iron sensors including covalently immobilized ferrozine applied to iron containing solutions containing a concentration of Fe²⁺ equal to 50 μM, and a concentration of Fe²⁺ equal to 100 μM.

FIG. 6A is a plot of the effect of pH variation in iron (Fe²⁺) containing solutions on absorption characteristics of iron sensors having covalently immobilized ferrozine, in accordance with one embodiment of the present disclosure.

FIG. 6B is a plot of the effect of variations of salinity and temperature in iron (Fe²⁺) containing solutions on absorption characteristics of iron sensors having covalently immobilized ferrozine, in accordance with one embodiment of the present disclosure.

FIG. 7 is dissolved Fe²⁺ 2-dimensional distribution pattern scanned from an iron sensor having covalently immobilized ferrozine that was applied to a homogenized sediment, in accordance with one example of the present disclosure.

FIG. 8 depicts the average Fe²⁺ profile (line) that was obtained by averaging the horizontal pixel layers of the 2-dimensional Fe²⁺ distribution pattern in FIG. 7 and the average Fe²⁺ profile (open circle) that was obtained from pore water separated from the homogenized sediment used in FIG. 7 based on a spectrophotometric method.

FIG. 9A is a visible image (green band) of a core sample of sediment with a low concentration of dissolved sulfide taken from central Smithtown Bay, Long Island Sound, N.Y. (USA).

FIG. 9B is a two dimensional Fe²⁺ distribution pattern that was measured from an iron sensor having covalently immobilized ferrozine that was in contact with the sediment sample that provided the visible image depicted in FIG. 9A.

FIG. 10A is a visible image of a sediment box core retrieved following in-situ Fe²⁺ measurement in intertidal sediment with high dissolved sulfide from taken from Flax Pond, Long Island, N.Y. (USA).

FIG. 10B is a two dimensional Fe²⁺ distribution pattern that was measured from the iron sensor having covalently immobilized ferrozine that was in contact with the sediment sample that provided the visible image depicted in FIG. 10A.

FIG. 11 is a plot of the average Fe²⁺ concentration in the maximum zone of the core samples that provided the two dimensional Fe²⁺ distribution patterns that are depicted in FIGS. 9B and 10B.

FIG. 12A is a visible image of a sediment core taken from central Long Island Sound, Smithtown Bay, Smithtown Bay, Long Island Sound, N.Y. (USA).

FIG. 12B is a 2-dimensional Fe²⁺ distribution corresponding to visible image depicted in FIG. 12A.

FIG. 12C is a horizontal Fe²⁺ concentration profile extracted along the section line C-C in FIG. 12B.

FIG. 12D is a horizontally averaged vertical Fe²⁺ profile of FIG. 12B.

### DETAILED DESCRIPTION

Detailed embodiments of the present disclosure are described herein; however, it is to be understood that the disclosed embodiments are merely illustrative of the compositions, structures and methods of the disclosure that may be embodied in various forms. In addition, each of the examples given in connection with the various embodiments are intended to be illustrative, and not restrictive. Further, the figures are not necessarily to scale, some features may be exaggerated to show details of particular components. Therefore, specific structural and functional details disclosed herein are not to be interpreted as limiting, but merely as a representative basis for teaching one skilled in the art to variously employ the compositions, structures and methods disclosed herein. References in the specification to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment.

An optical iron sensor is disclosed herein for measuring iron (Fe²⁺) concentration, e.g., measuring two-dimensional Fe²⁺ distributions, in water and earthly sediments, such as marine sediments. Because of the sensitivity of Fe²⁺ to oxygen in air during sediment sampling and pore water handling, an in-situ measurement method with high spatial and temporal resolution is desirable. In some embodiments, the structures and methods described herein provide for measurements of Fe²⁺ concentrations in 2 dimensional images in natural sediment without exposure to air.

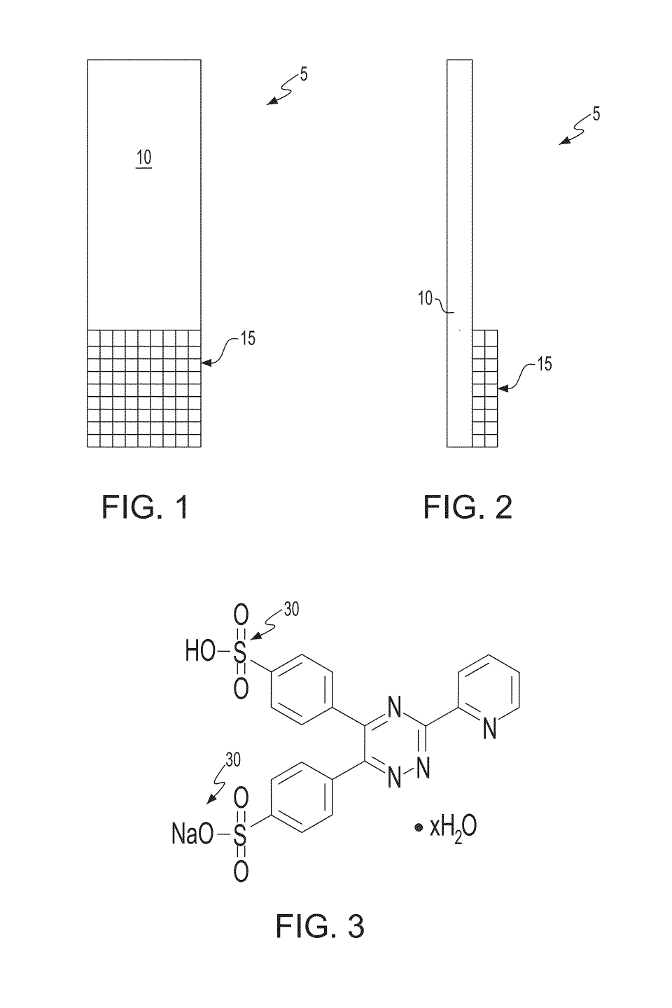

FIGS. 1 and 2 depict one embodiment of an iron sensor 5 for measuring iron concentration, such as dissolved ferrous iron (Fe²⁺) content in water and earthly sediment, that includes a substrate, a ferrozine containing reagent for detecting iron (Fe), and a polymer covalently bonding the ferrozine containing reagent to the substrate. More specifically, in one embodiment, ferrozine (3-(2-pyridyl)-5,6-diphenyl-1,2,4-triazine-p,p′-disulfonic acid monosodium salt hydrate) that provides the Fe²⁺ indicator is covalently immobilized onto a transparent poly(vinyl alcohol) membrane 15 through a water soluble poly(N-isopropylacrylamide) polymer chain. The membrane 15 may be backed by a polyester sheet 10. Ferrozine is a highly selective indicator for Fe²⁺. Ferrozine when deployed in water samples and earthly sediments containing iron reacts with Fe²⁺, and not Fe³⁺, to form a magenta colored Fe(ligand)₃²⁺ complex in aqueous solution, with maximum absorbance at 562 nm.

The substrate provides structural support for the reagent so that the iron sensor 5 can be applied to an iron containing sample, such as marine sediment, for measurement of the iron concentration, e.g., Fe²⁺ concentration, that is present in the iron containing sample. The substrate typically includes a membrane 15 for supporting the iron sensing reagent, e.g., ferrozine (3-(2-Pyridyl)-5,6-diphenyl-1,2,4-triazine-p,p′-disulfonic acid monosodium salt hydrate), and a backer 10 to provide rigidity. The membrane 15 may be composed of a material that is transparent, translucent or opaque. In some examples, the membrane 15 may be composed of poly(vinyl alcohol), poly(vinyl chloride), D4 polyurethane hydrogel or ethyl cellulose. The membrane 15 typically has a surface area that is suitable for supporting enough reagent, i.e., ferrozine, to measure the concentration of iron (Fe), i.e., Fe²⁺ concentration, that is present in the iron-containing sample. For example, in one embodiment, the membrane 15 of the substrate may have a surface area ranging from 1 cm² to 300 cm². The thickness of membrane 15 can be 15 microns or less. In some embodiments, the thickness of the membrane 15 may range from 5 microns to 10 microns. In one example, the membrane 15 is composed of transparent poly(vinyl alcohol) and has a thickness of 15 microns.

In some embodiments, the structural rigidity of the membrane 15 may be increased by a backer 10. The backer 10 may be composed of a transparent, translucent or opaque material. Typically, the backer 10 is composed of a thermoplastic or thermosetting polymer, such as polyester. Some examples of polyesters that are suitable for the backer 10 include Polyglycolic acid (PGA), Polylactic acid (PLA), Polycaprolactone (PCL), Polyethylene adipate (PEA), Polyhydroxyalkanoate (PHA), Polyethylene terephtalate (PET), Polybutylene terephthalate (PBT), Polytrimethylene terephthalate (PTT), Polyethylene naphthalate (PEN) and derivatives thereof. A substrate including a combination of a membrane 15 and a back 10 may have a thickness that is as great as 200 microns. In one embodiment, the combination of the membrane 15 and the backer 10 provide a substrate having a thickness that may range from 100 microns to 150 microns. In one example, a substrate including a membrane 15 composed of poly(vinyl alcohol) and a backer composed of polyethylene terephtalate (PET) has a thickness of 150 microns.

In one embodiment, the membrane 15 includes the ferrozine containing reagent for detecting iron (Fe²⁺), in which a polymer is covalently bonding the ferrozine containing reagent to the membrane 15 of the substrate. The covalent bonding of the ferrozine containing reagent to the membrane 15 may be referred to as “covalently immobilized ferrozine” when describing the iron sensor 5 of the present disclosure. In some embodiments, in addition to ferrozine (3-(2-Pyridyl)-5,6-diphenyl-1,2,4-triazine-p,p′-disulfonic acid monosodium salt hydrate), the ferrozine contain reagent may also include sulfonate derivatives of 1,10-phenanthroline. In one embodiment, the concentration of ferrozine that is present on the membrane 15 ranges from 5 to 100 μg/cm². In another embodiment, the concentration of ferrozine that is present on the membrane ranges from 10 to 50 μg/cm².

The ferrozine containing reagent for detecting iron (Fe) is typically covalently bonded to the membrane 15 of the substrate by a polymer. The covalent bonding of the polymer to the ferrozine containing reagent may be to a sulfonate group of ferrozine. In one example, the ferrozine containing reagent is immobilized on a membrane 15 composed of transparent poly(vinyl alcohol) through a water soluble poly(N-isopropylacrylamide) polymer chain. The covalent bonding of the ferrozine containing reagent to the membrane 15 may be provided by reacting ferrozine (3-(2-pyridyl)-5,6-diphenyl-1,2,4-triazine-p,p′-disulfonic acid monosodium salt hydrate) with phosphorus pentachloride (PCl₅) to provide ferrozine sulfonyl chloride, reacting ferrozine sulfonyl chloride with allylamine to provide ferrozine sulfonamide, and polymerizing a solution of the ferrozine sulfonamide and N-isopropylacrylamide onto a poly(vinyl alcohol) membrane surface 15, in which the poly(vinyl alcohol) membrane surface includes at least one unsaturated alkyl bond. Referring to FIG. 3, ferrozine has two sulfonate groups 30 (R—SO₂O⁻), which can be modified for covalent immobilization. The term “covalent bonding” as used herein is a form of chemical bonding that is characterized by the sharing of pairs of electrons between atoms.

The covalent immobilization principle used herein provides that both the ferrozine containing reagent and the membrane 15, e.g., poly(vinyl alcohol) membrane, are modified with side chains having unsaturated alkyl double bonds, in which the modified ferrozine containing reagent and the modified membrane 15 are then copolymerized with an amide containing polymer, such as N-isopropylacrylamide. In one embodiment, ferrozine is modified with an unsaturated alkyl amine, such as allylamine (C₃H₅NH₂), to produce a sulfonamide (RSO₂NHR′, R=organic group) with a unsaturated alkyl bond. Initially, the ferrozine (3-(2-pyridyl)-5,6-diphenyl-1,2,4-triazine-p,p′-disulfonic acid monosodium salt hydrate) may be reacted with a chloride-containing compound, such as phosphorus pentachloride (PCl₅), to form ferrozine sulfonyl chloride. Following the initial reaction of the ferrozine and PCl₅, the product of ferrozine sulfonyl chloride may be extracted using anhydrous acetone. A longer reaction time may increase the yield, but may destroy the triazine functional group of ferrozine which chelates iron.

In some embodiments, the covalent bonding of the modified ferrozine to the membrane 15 of the substrate is provided by a polymerization reaction, in which the polymer chain linking the modified ferrozine to the membrane 15 is provided by a polymeric amide. Polymeric amides include polymers having repeated amide groups. An amide is an organic compound that contains a functional group consisting of a carbonyl group (R—C=0) linked to a nitrogen atom (N). One example of a polymeric amide suitable for use for providing the polymer chain liking the modified ferrozine to the membrane is N-isopropylactrylamide. In one example, the polymer chain linking ferrozine onto the sensor membrane 15 is poly(N-isopropylacrylamide), which is formed from monomer N-isopropylacrylamide without crosslinker. Poly(N-isopropylacrylamide) has temperature sensitive water solubility. It can be dissolved in water when the temperature is lower than 31° C., but may be rapidly precipitated from solution when the temperature is higher than 31° C. This property allows for separating and purifying the indicator immobilized poly(N-isopropylacrylamide) polymer chain by altering solution temperature (between 15 and 37° C.) and centrifuging, permitting evaluation of immobilization efficiency and indicator loading.

In order to anchor the ferrozine bonded poly(N-isopropylacrylamide) chain on the membrane 15, the membrane surface may also modified with unsaturated alkyl bonds. The poly(vinyl alcohol) membrane can be made by mixing poly(vinyl alcohol) water solution with glutaraldehyde and acid, resulting in abundant aldehyde residuals that are available in the membrane 15 for binding unsaturated alkyl amine, such as allylamine. Although the membrane 15 can be dried before further reaction, greater amounts of allylamine can be loaded in the membrane 15 if it is mixed initially with the solution of poly(vinyl alcohol), glutaraldehyde and acid. In some embodiments, casting the mixture onto the backer 10 produces a hydrogel, wherein following drying forms a membrane 15 of PVA having a thickness ranging from 5 μm to 15 μm.

In some embodiments, the iron sensor 5 described above provides a single use planar optical sensor for measuring high resolution, two dimensional iron, i.e., Fe²⁺, distributions in marine sediments. When applied to iron containing samples, the ferrozine containing reagent that is covalently bonded to the membrane of the iron sensor 5 reacts with iron (Fe²⁺) ions to form a ferrozine-Fe²⁺ complex. When ferrozine (3-(2-Pyridyl)-5,6-diphenyl-1,2,4-triazine-p,p′-disulfonic acid monosodium salt hydrate) is employed as the reagent on a transparent or colorless substrate, such as a membrane 15 composed of PVA and a backer 10 composed of PET, and the iron sensor 5 is deployed in solutions containing iron (Fe), e.g., Fe²⁺ ions, the membrane 15 turns to a violet red color with a maximum absorbance wavelength at 562 nm due to the formation of Ferrozine-Fe²⁺ complex in the membrane 15. The absorbance of the iron sensor 5 at 562 nm shows excellent linear relationships versus Fe²⁺ concentrations in the range of 0-200 μM, with a lower detection limit of 4.5 μM. The rugged physical properties of the iron sensor 5 enable it to be directly inserted into iron containing samples, such as earthly sediments, without damage. The membrane 15 of poly(vinyl alcohol) gel is a good polymeric support for Fe²⁺ optical sensors, because it is transparent and has no absorption in the visible and ultraviolet regions down to about 230 nm. Furthermore, this poly(vinyl alcohol) gel is a hydrophilic polymer and shows good ionic permeability. An unreacted iron sensor 5 is stable and can be stored for at least two years in dark at room temperature in a sealed bag without response change. In one embodiment, an iron sensor 5 that has reacted with Fe²⁺ is stable for at least 1 month at room temperature, e.g., 20° C. to 25° C.

In another embodiment, the iron sensor 5 that has reacted with Fe²⁺ is stable for a time period ranging from 1 month to 1 year at room temperature, e.g., 20° C. to 25° C. In some embodiments, the iron sensor 5 is transparent, allowing the Fe²⁺ distribution patterns to be directly related to visually evident physical features at the time of reaction, and thus providing a basis for interpretation and generalization of any associated reaction processes. In some embodiments, the iron sensors 5 can be used in scientific applications, such as in environmental sciences. The iron sensors 5 may also be employed by homeowners, in which example applications may include well water supply analysis or saturated garden soil analysis. The iron sensors 5 may also be employed in industrial applications, such as solution analysis of field locations.

In one embodiment, the method for measuring iron concentration using the above described iron sensor 5 includes inserting the iron sensor 5 into an iron (Fe) containing sample, and measuring the optical properties of the iron sensor 5 after the ferrozine containing reagent reacts with the iron (Fe²⁺) ions in the iron containing sample. The optical properties of the reacted iron sensor 5 can be used to determine the concentration of the iron (Fe²⁺) ions in the iron containing sample. The ferrozine containing reagent which may be covalently immobilized onto the membrane 15 of the iron sensor 5 is the only reagent that is required to measure the iron (Fe²⁺) ions in the iron containing sample. The methods and structures disclosed herein do not require additionally liquid reagents to be applied to either the iron containing sample, or the iron sensor 5, in order to determine the concentration of the iron (Fe²⁺) ions in the iron containing sample.

The iron (Fe) containing sample being measured by the iron sensor 5 may include a liquid solution of iron (Fe²⁺) ions, sediment containing iron or a combination thereof. The concentration of the iron (Fe²⁺) ions that is present in the iron containing sample that can be measured by the iron sensor 5 may be as great as 200 μM, and the minimum concentration of iron (Fe²⁺) ions measured by the iron sensor 5 may be as low as 4.5 μM. In one embodiment, the iron containing sample may have a pH ranging from 3.5 to 10.5. In one embodiment, the iron containing sample has a pH ranging from 4.0 to 10. In yet another embodiment, the iron containing sample has a pH ranging from 4.0 to 9.0. It is noted that the above noted pH's for the iron containing sample are provided for illustrative purposes only, and are not intended to limit the present disclosure to iron (Fe) containing sample having only those pH's that are described above.

The iron sensor 5 is applied for a time period that is suitable for reaction between the ferrozine that is present on the membrane 15 of the iron sensor 5 to react with the Fe²⁺ ions in the iron containing sample to form a ferrozine-Fe²⁺ complex (e.g., Fe(ferrozine)₃²⁺). To provide sufficient reaction time, the iron sensor 5 may be applied to the iron containing sample for a time period of 25 minutes or greater. In some embodiments, the iron sensor 5 may be applied to the iron containing sample for a time period of 30 minutes or greater. In yet another embodiment, the iron sensor 5 may be applied to the iron containing sample for a time period of 45 minutes or greater. It is noted that the above reaction time periods are provided for illustrative purposes only, and are not intended to limit the present disclosure to only the disclosed time periods.

When iron sensors 5 including colorless and transparent membranes 15 are deployed in iron containing samples, e.g., Fe²⁺ solutions or natural marine sediment samples, a violet-red color typically develops with a maximum absorption wavelength between 550 nm to 570 nm, e.g., 562 nm, due to the formation of Ferrozine-Fe²⁺ complex in the sensor membrane 15. In some embodiments, after the iron sensor 5 has been applied to the iron containing sample, the optical properties of the reacted iron sensor 5 may be measured by comparison of the color of the reacted iron sensor 5 to a color chart correlating color to Fe²⁺ concentration. In some embodiments, after the iron sensor 5 has been applied to the iron containing sample, the optical properties of the reacted iron sensor 5 may be measured by scanning the sensor with a flatbed optical scanner or hand held scanner. In one example, images may be readily obtained from the membrane 15 of the iron sensor 5 by using a scanner or inexpensive LED excitation light and commercial grade digital cameras, with typical pixel resolution of ˜50×50 μm over areas that are greater than 150 cm².

The optical properties of the iron sensor 5 may be measured to determine the concentration of the iron (Fe²⁺) ions in the iron containing sample. In one embodiment, the concentration of the iron (Fe²⁺) ions in the iron containing sample may be measured by measuring an absorbance of a wavelength through the sensor and correlating the absorbance to a concentration of iron (Fe²⁺) ions in the ferrozine-Fe²⁺ complex on the membrane of the sensor. The absorbance of the iron sensor 5 is directly proportional to Fe²⁺ concentration. Correlating of the absorbance to the concentration of iron (Fe²⁺) ions may be through Beer-Lambert law. In one embodiment, there is a linear correlation between absorbance and the concentration of iron (Fe²⁺) ions in the ferrozine-Fe²⁺ complex that is formed on membrane 15 of the iron sensor 5. In one embodiment, as the absorbance measured increases, the concentration of iron (Fe²⁺) ions in the ferrozine-Fe²⁺ complex increases. The absorbance attained by the iron sensor 5 is independent of temperature before or after development, salinity and pH changes.

The iron sensor 5 is simple, stable (irreversible), and precise, and is suitable for measuring virtually continuous two-dimensional Fe²⁺ distributions in intertidal flat and subtidal sediment samples. The complex heterogeneous distribution patterns of Fe²⁺ associated with both inhabited and abandoned biogenic structures and other natural diagenetic heterogeneity, are readily revealed and can be related directly to the corresponding visible images of sedimentary features.

The following examples are provided to further illustrate the methods and structures of the present disclosure and demonstrate some advantages that arise therefrom. It is not intended that the present disclosure be limited to the specific examples disclosed.

### EXAMPLES

### Fabrication of Iron Sensors Having Covalently Immobilized Ferrozine

In order to obtain a stable planar iron, i.e., Fe²⁺ ion, sensor that is suitable for application to earthly sediments, such as marine environments, different immobilization methods and polymer matrix were studied. Polymer matrixes, such as poly(vinyl alcohol), poly(vinyl chloride), D4 polyurethane hydrogel, and ethyl cellulose were examined for use as a membrane to support ferrozine immobilization. Poly(vinyl alcohol) was chosen due to its UV-Vis range transparency, easy chemical modification and hydrophilic properties. Polyester Mylar plastic sheet was selected as a backer for the membrane, because of polyester's stability for adhering to the poly(vinyl alcohol) polymer membrane under different conditions, mechanical flexibility and rigidity (easy to insert into sediment), UV-VIS range light transparency, and chemical resistance.

Immobilization methods of ferrozine in poly(vinyl alcohol) membrane were studied. In one example, ferrozine was physically entrapped into the polymer matrix to form a transparent sensor foil. However, it was determined that the immobilized ferrozine leaked out of the membrane when this type of sensor foil was immersed in water. In another example, ferrozine was bonded to a membrane using ionic bond immobilization. Ion pairs of the water soluble ferrozine (negative charge) and a polymer poly(diallyldimethylammonium) (positive charge) were prepared, and then the ion-pair polymer was physically entrapped into a poly(vinyl alcohol) membrane. It was determined that this type of sensor responded to Fe²⁺ well in low salinity or fresh water samples, e.g., tap water, ground water or surface water, but was not stable in high ionic strength seawater. The ionic bond immobilized ferrozine was quickly released from the sensor membrane when it was deployed in marine sediment.

Another ferrozine immobilization method that was covalent bond immobilization. The water soluble ferrozine molecule was covalently bonded onto the poly(vinyl alcohol) membrane surface through a water soluble polymer chain, which can extend into a contacting solution when the sensor membrane is deployed. Furthermore, a water soluble polymer chain can easy interact with adjacent chains in solution so that immobilized ferrozine can form the magenta complex Fe(ferrozine)₃²⁺ on the membrane surface. This type of sensor membrane was stable, and no loss of ferrozine was observed in high salinity seawater and porewater samples. The details of the experimentation to provide covalent bond immobilization are now discussed in greater detail.

Ferrozine (3-(2-Pyridyl)-5,6-diphenyl-1,2,4-triazine-p,p′-disulfonic acid monosodium salt hydrate) was obtained from J. T. Baker Inc. (Philipsburg, N.J.). The ferrozine was modified with allylamine to produce a sulfonamide with an unsaturated alkyl bond. Specifically, ferrozine in an amount of 0.5 g was mixed with 1.0 gram of PCl₅ in an agate mortar and ground for 5 minutes in a hood. The pentachloride, was purchased from Sigma-Aldrich.

The product ferrozine sulfonyl chloride was extracted twice with 10 mL anhydrous acetone, and the extract solution was combined and filtered. 100 μl of allylamine was dissolved in 2 mL anhydrous acetone, the mixture was gently added into the extracted ferrozine-sulfonyl chloride solution at 0° C. while stirring. The pH of the reaction solution was adjusted to 10 using 1 M NaOH solution, and reaction was run for 2-3 h at 0° C. while stirring. The solvent was then removed by a nitrogen stream and the sulfonamide residue was used for further reaction.

The poly(vinyl alcohol) membrane was modified with short carbon chains having unsaturated alkyl bonds, and was prepared on a backer 10 of Mylar polyester film. Specifically, 1.0 mL of 1% allylamine, 1.0 mL of 5% glutaraldehyde and 1 mL of 4 M HCl were added into 10 mL of 4.2% poly(vinyl alcohol) in a 20-mL vial. The poly(vinyl alcohol), allylamine, and glutaraldehyde (50% aqueous solution) were purchased from Sigma-Aldrich. The mixture was stirred for 5 minutes at room temperature (e.g., 20° C. to 25° C.) and then cast on a transparent polyethylene terephthalate (PET) polyester film (15 cm×20 cm). The polyethylene terephthalate (PET) polyester film sheet (thickness 125 μm) was obtained from Ridout Plastics (San Diego, USA). A layer of hydrogel was formed in 15 minutes and was slowly dried in a hood for about 3 hours to 5 hours. The thickness of this membrane 15 was approximately 10 μm.

The modified ferrozine residue was re-dissolved in water. In some experiments, acetone was added if the residue does not completely dissolve. The solution was mixed with 0.2 grams of N-isopropylacrylamide, and 10 mg of ammonium persulfate in 60 ml water while stifling. When the reagents were dissolved, 20 μL of TEMED (N,N,N,N-Tetramethyl-Ethylenediamine) was added, and the mixture was quickly cast on the modified poly(vinyl alcohol) membrane. The polymerization reaction tying ferrozine to the membrane was carried out for 2 hours under a nitrogen (N₂) atmosphere. When the reaction was completed, the solution was collected and the membrane was rinsed and dipped in tap water for 1 hour (repeat three times) to remove any unbound ferrozine. The final sensor including ferrozine covalently bonded to the poly(vinyl alcohol) membrane is colorless, transparent and uniform with a total thickness of 135 μm (sensor membrane layer ˜10 μm), and is hereafter referred to within the Examples section of this paper as an “iron sensor with covalently immobilized ferrozine”.

### Sample Preparation and Measurement Procedures

Procedure for Measurements of Standard Solution Containing Fe²⁺ with Iron Sensors with Covalently Immobilized Ferrozine.

Standard solutions containing 0-300 μM Fe²⁺ were prepared by diluting a stock solution (10 mM in 1% hydroxylamine hydrochloride) in pH 5.5 buffer. The stock solution of Fe²⁺ was prepared from ferrous ammonium sulfate (Fisher Sci.) in 1% hydroxylamine hydrochloride (Fisher Sci.).

Before being applied to the standard solution, the iron sensors with covalently immobilized ferrozine were sectioned to 1 cm×2 cm subsamples. The subsamples of the iron sensors with covalently immobilized ferrozine were immersed in the standard solution containing Fe²⁺ at room temperature, e.g., 20° C. to 25° C. Following reaction with the standard solution containing Fe²⁺, the subsamples of the iron sensors with covalently immobilized ferrozine were then removed from the solutions.

Procedure for Fe²⁺ Measurements of Homogenized Fe²⁺ Containing Sediment with Iron Sensors with Covalently Immobilized Ferrozine.

Surface sediment obtained from central Long Island Sound, USA, (depth ranging from 0-2 cm; salinity=27-28) was sieved (1 mm, no water added), homogenized by hand mixing, and transferred into a glass tank. The inside front-face of the tank was covered with a 14 cm×18 cm transparency film, which was used to position later inserted iron sensors with covalently immobilized ferrozine between the sidewalls of the glass tank and the transparent film prior to exposure with the homogenized sediment being contained within the glass tank. Bottom water from the sampling site was added to the glass tank. The sediment microcosm was incubated in the dark at room temperature (22° C.) for 2 weeks.

Following incubation, iron sensors with covalently immobilized ferrozine were then inserted between the transparency film and the front-face of the glass tank. The transparency film was then removed from the glass tank so that the sensing face of the iron sensors with covalently immobilized ferrozine contacted the homogenized sediment. After a reaction time of 30 minutes, a physically visible image of the homogenized sediment contacted by the iron sensor having covalently immobilized ferrozine was taken before removing the reacted iron sensor with covalently immobilized ferrozine, which was then rinsed with water.

The two-dimensional Fe distribution image obtained from the iron sensor having covalently immobilized ferrozine applied to the homogenized sediment was scanned using a flatbed scanner (Cannon) along with a set of calibration iron sensors. For calibration sensors, iron sensors with covalently immobilized ferrozine were applied to the standard solution containing Fe²⁺, which is described in the above procedure for measurements of standard solution containing Fe²⁺ with iron sensors with covalently immobilized ferrozine. The obtained image was analyzed with Maxim DL image processing software version 2.0× (Diffraction Limited) and Image-Pro plus version 4.1 for Windows (Media Cybernetics). The isolated green bands of the color images were used to calculate the absorbance within individual pixels.

Procedure for Comparative Measurements of Homogenized Sediment Containing Fe²⁺ with Traditional Wet Chemical Methods.

Following measurement of the Fe²⁺ concentration of the homogenized sediment using the iron sensors with covalently immobilized ferrozine, as described above in the procedure for measurements of homogenized sediment containing Fe²⁺ with iron sensors with covalently immobilized ferrozine, the microcosm was sub-cored by several small cylinder cores and quickly transferred into a nitrogen filled glove bag.

The sediment was sliced at 1 cm depth intervals in the nitrogen glove bag, transferred into 15 mL centrifuge tubes, which were completely filled, and then centrifuged at 5000 rpm for 10 min. The obtained pore water samples were immediately transferred into a nitrogen glove bag, filtered through 0.2 μm filters and acidified with HCl. Dissolved iron in the acidified pore water samples was determined by the ferrozine spectrometric method that is described in Stookey, L. L., 1970. Ferrozine—a new spectrophotometric reagent for iron. Anal. Chem. 42:779-781.

Procedure for Fe²⁺ Measurements from Undisturbed Intact Sediment Cores Containing Fe²⁺ with Iron Sensors Having Covalently Immobilized Ferrozine.

Undisturbed intact sediment cores were collected from Long Island Sound using acrylic box corers. Cores were transferred to the laboratory and kept in the dark at room temperature (22° C.-25° C.) with constant aeration of overlying water (salinity 27). Box cores were sub-cored with a glass sided box open at both ends.

Iron sensors with covalently immobilized ferrozine where sectioned to dimensions of 14 cm×15 cm, and were mounted on the inside of the front-faces of the sub-corer before it was inserted into sediment. After sealing the bottom with a plate gasket, the sub-core was continuously aerated, and kept in the dark at room temperature (22° C.-25° C.). After a reaction time of 30 minutes, a visible image of the sediment sample surface was then taken before removing the reacted iron sensor with covalently immobilized ferrozine, which was then rinsed with water.

A two-dimensional Fe distribution image was obtained from the reacted iron sensor having covalently immobilized ferrozine by scanning the reacted iron sensor with a flatbed scanner (Cannon). The obtained image was analyzed with Maxim DL image processing software version 2.0× (Diffraction Limited) and Image-Pro plus version 4.1 for Windows (Media Cybernetics). The isolated green bands of the color images were used to calculate the absorbance within individual pixels.

Procedure for In Situ Fe²⁺ Measurements from Undisturbed Intact Sediment Cores Containing Fe²⁺ with Iron Sensors Having Covalently Immobilized Ferrozine.

Application of the iron sensors having covalently immobilized ferrozine was also tested by in situ measurement of 2-dimensional Fe²⁺ distribution in sediment from Flax Pond, a back barrier salt marsh environment located on the north shore of Long Island, USA. In-situ measurement was performed at low tide by using a 6 cm×15 cm×20 cm glass box corer open at both ends. An iron sensor having covalently immobilized ferrozine was installed on the inside of one face of the glass box corer, and the corer vertically inserted into the sediment to 15 cm depth and kept there for 30 min. After the reaction, the two ends of the corer were sealed and the core was gently pulled out for visible imaging. The sediment was then discarded. The color-developed, i.e., reacted, iron sensor having covalently immobilized ferrozine was then rinsed with distilled water and brought back to the laboratory for absorbance measurement.

A two-dimensional Fe²⁺ distribution image was obtained from the reacted iron sensor having covalently immobilized ferrozine by scanning the reacted iron sensor with a flatbed scanner (Cannon). The obtained image was analyzed with Maxim DL image processing software version 2.0× (Diffraction Limited) and Image-Pro plus version 4.1 for Windows (Media Cybernetics). The isolated green bands of the color images were used to calculate the absorbance within individual pixels.

Measurements of Absorption Behavior, Reaction Response Time and Stability Measurements of Iron Sensors with Covalently Immobilized Ferrozine Applied to Iron Containing Samples

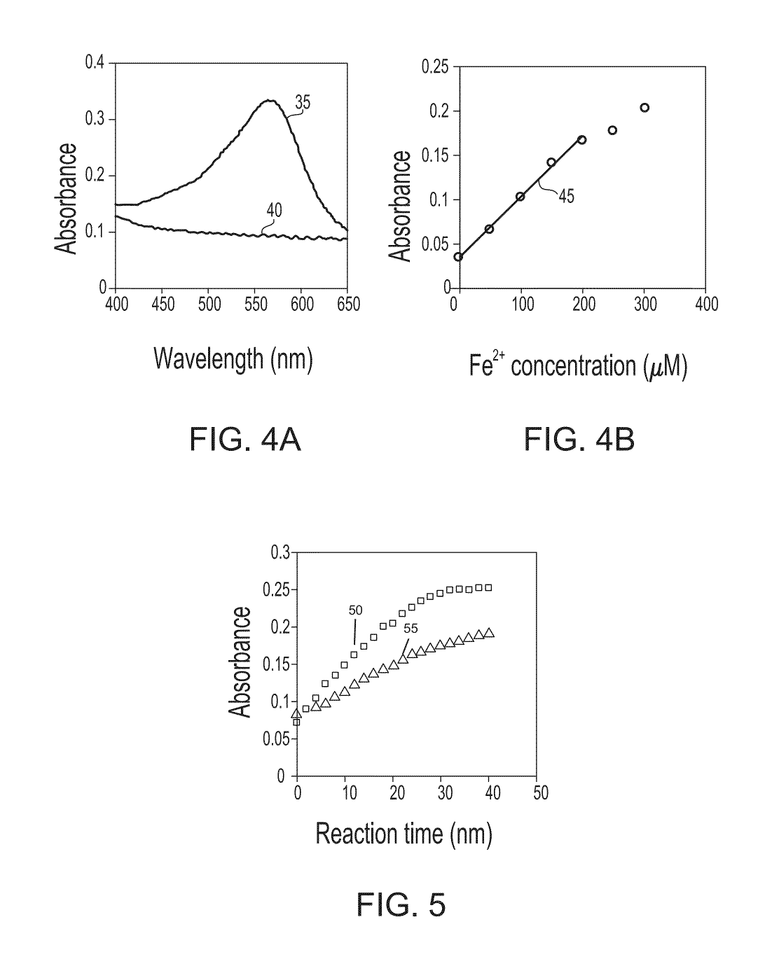

The ferrous complex of ferrozine, i.e., Fe(ferrozine)₃²⁺, shows a single absorption band in solution with maximum absorbance wavelength at 562 nm. Similarly, the visible absorption spectrum of the iron sensor with covalently immobilized ferrozine exhibited a single absorption peak at 562 nm after reaction with Fe²⁺, as depicted in FIG. 4A, indicating that the physical characteristics of the ferrous-ferrozine complex formed on the membrane is equivalent with that in solution.

Plot line 35 in FIG. 4A depicts the absorption spectra of an iron sensor with covalently immobilized ferrozine that was applied to an iron containing solution of 500 μM Fe²⁺. Plot line 40 in FIG. 4A is the absorption spectra of an iron sensor having the covalently immobilized ferrozine that was applied to a control solution in which the Fe²⁺ concentration was 0 μM. The iron containing solution and the control solution, as well as the procedures for applying the iron sensor with covalently immobilized ferrozine, are describe above in the section of this paper titled “Procedure for measurements of standard solution containing Fe²⁺ with iron sensors with covalently immobilized ferrozine”. Each of the solutions that that produced the absorption spectra from the iron sensor having the covalently immobilized ferrozine that was applied thereto had a pH=5.5.

The reaction time for the application of the iron sensor with covalently immobilized ferrozine to the iron containing solution and the control solution was 30 minutes. The temperature at which the iron sensors with covalently immobilized ferrozine were applied to the iron containing solution and the control solution was 22° C. The absorbance spectra, i.e., plot lines 35 and 40 in FIG. 4A, was measured from the iron sensors including the covalently immobilized that were applied to the iron containing solution and the control solution using a POLARstar Omega multifunctional plate reader (BMG, Germany) using UV-VIS absorbance mode.

At the maximum absorption wavelength, the absorbance of the iron sensor having the covalently immobilized ferrozine obeyed Beer-Lambert law and was proportional to the concentration of ferrous in solution. Referring to FIG. 4B, a good linearity of response of absorbance measured from iron sensors with covalently mobilized ferrozine applied to iron containing solutions having an Fe²⁺ concentration ranging of 0 μM-200 μM (μM=μmol/L) was found, which encompasses Fe²⁺ concentrations found in many natural marine sediments. The iron containing solutions having an Fe²⁺ concentration ranging of 0 μM-200, as well as the procedures for applying the iron sensor with covalently immobilized ferrozine, are describe above in the section of this paper titled “Procedure for measurements of standard solution containing Fe²⁺ with iron sensors with covalently immobilized ferrozine”. The lower detection limit was 4.5 μM (3σ). The response was nonlinear and the slope was reduced when the concentration of Fe²⁺ was higher than ˜200 μM, however, a less sensitive extension of the measurement range can be made using a standardization curve if the concentration of Fe²⁺ in the sample is between 200 μM-300 μM. The data included in FIG. 4B was measured from the iron sensors including the covalently immobilized that were applied to the iron containing solutions having an Fe²⁺ concentration ranging of 0 μM-300 μM using a POLARstar Omega multifunctional plate reader (BMG, Germany) using UV-VIS absorbance mode.

The response time of the iron sensor with covalently immobilized ferrozine to attain a stable absorbance was evaluated by studying the reaction kinetics of different concentrations of Fe²⁺ with the immobilized ferrozine that was present on the iron sensors. FIG. 5 is a plot of the reaction kinetics of the iron sensor having the covalently immobilized ferrozine when applied to different solutions of iron (Fe²⁺) concentrations. The solutions of iron (Fe²⁺) concentrations were prepared in accordance with the section of this paper titled “Procedure for measurements of standard solution containing Fe²⁺ with iron sensors with covalently immobilized ferrozine”. Referring to FIG. 5, plot line 55 is a measurement of reaction kinetics on an iron sensor with covalently immobilized ferrozine as applied to an iron containing solution having a Fe²⁺ concentration of 50 μM. Plot line 50 is a measurement of reaction kinetics on an iron sensor with covalently immobilized ferrozine as applied to a ferrozine containing solution having a Fe²⁺ concentration of 100 μM. Each of the solutions, i.e., 50 μM Fe²⁺ concentration solution and 100 μM Fe²⁺ concentration solution, had a pH=5.5, and the iron sensors having the covalently immobilized ferrozine was applied to iron containing solution at room temperature (22° C.). The reaction time for the application of the iron sensor including the covalently immobilized ferrozine to the iron containing solutions was as great as 40 minutes, and the maximum absorbance wavelength was 562 nm.

Referring to FIG. 5, the equilibration response time of the iron sensor with covalently immobilized ferrozine depends on the concentration of Fe²⁺ in iron containing solution. When the Fe²⁺ concentration in the iron containing solution was high, e.g., 100 μM or greater, it took 26 minutes of reaction time with the iron containing solution to reach 90% of the maximum response and 30 minutes to completely equilibrate, as illustrated by plot line 50. However, the iron sensor with covalently immobilized ferrozine did not reach equilibration after 30 minutes of reaction with the iron containing solution when Fe²⁺ concentration was 50 μM, as illustrated by plot line 55. Therefore, a fixed reaction time, 30 minutes, was chosen for all measurements, standards and samples, in order to obtain accurate and precise results.

Once the violet-red Fe-ferrozine complex formed, the absorbance of the iron sensor having the covalently immobilized ferrozine was stable for at least a month if the iron sensor were sealed in a plastic bag and stored in the dark. It was also determined that the sensor properties are essentially constant for at least two years when the unreacted iron sensor was sealed in a bag and stored in the dark at room temperature.

Measurements of the Effect of pH Variation, Dissolved Oxygen, Temperature and Salinity in Iron Containing Samples on Iron Sensors Having Covalently Immobilized Ferrozine

pH and dissolved oxygen are parameters in biogeochemistry and are typically characterized by sharp gradients in marine sediments just below the overlying water—sediment interface and around irrigated biogenic structures. pH gradients may reach 1-2 pH unit within a few millimeter distances in surficial marine sediments, accompanied by changes in the concentration of dissolved oxygen from several hundred micromolar to zero.

The effects of pH and dissolved oxygen on the performance of iron sensor with covalently immobilized ferrozine were studied both in the presence and absence of Fe²⁺. In the absence of Fe²⁺, the blank absorbance of the sensor does not change when the pH in the contacting solution increases from 1 to 9 (under either oxic or anoxic conditions) or the concentration of dissolved oxygen decreases from 100% saturation to 0.

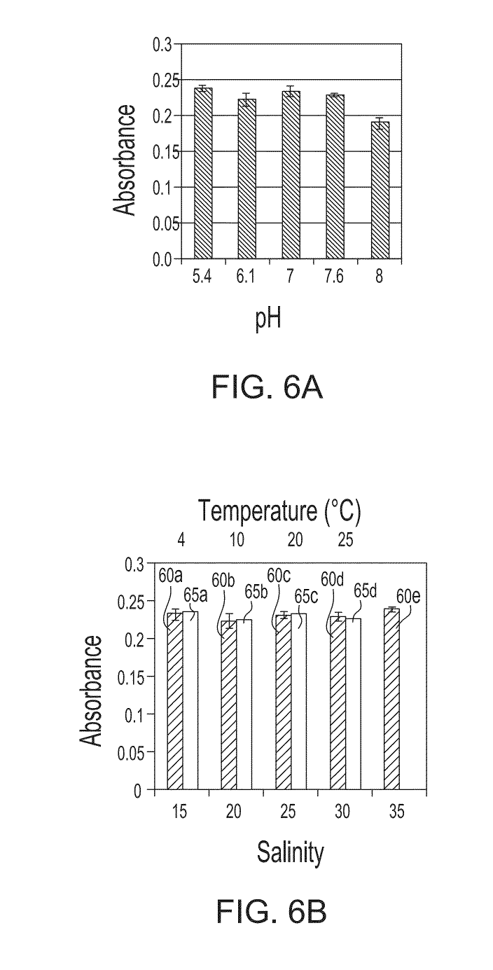

FIG. 6A is a plot of the effect of pH variation in iron (Fe²⁺) containing solutions on absorption characteristics of iron sensors having covalently immobilized ferrozine. The iron containing solutions included 100 μM Fe²⁺, and were prepared in accordance with the section of this paper titled “Procedure for measurements of standard solution containing Fe²⁺ with iron sensors with covalently immobilized ferrozine”. Under anoxic conditions, the pH of iron containing solutions did not affect the absorbance response of the iron sensors having the covalently immobilized ferrozine to Fe²⁺ over a pH range of 5.4-7.6, as depicted in FIG. 6A. pH electrode measurements were made using a Thermo Orion pH meter (Model 290A) equipped with a VWR SympHany mini-electrode (Ag/AgCl reference). Rapid oxidation of Fe²⁺ to Fe³⁺ and precipitation as ferric oxide at a pH greater than 6.1 prevented evaluation of response to Fe²⁺ at higher pH in the presence of O₂, but it is believed that Fe²⁺ is not stable naturally under such conditions. Examination of the pH dependence under anoxic conditions was carried out in buffer solutions bubbled with Ar for 20 minutes at room temperature (22° C.) to remove dissolved oxygen prior to adding Fe²⁺, and bubbling with Ar continued during the measurement of Fe²⁺. The sensor response was constant when the anoxic solution pH was less than 7.6, but decreased by 17% when pH increased to 8.0, as depicted in FIG. 6A. The slight decrease of sensor response when the pH of the iron containing solution is greater than 7.6 may have been attributed to the precipitation of Fe²⁺ by hydroxide at high pH.

FIG. 6B is a plot of the effect of variations of salinity and temperature in iron (Fe²⁺) containing solutions on absorption characteristics of iron sensors having covalently immobilized ferrozine. The effects of salinity and temperature on the iron sensor response were also evaluated by measuring the iron sensor absorbance in pH 5.5 buffered solutions in the presence of 100 μM Fe²⁺. The solutions of iron (Fe²⁺) were prepared using the procedures described in the above section of this paper titled “Procedure for measurements of standard solution containing Fe²⁺ with iron sensors with covalently immobilized ferrozine”. The plots identified by reference numbers 60a, 60b, 60c, 60d and 60e in FIG. 6B are absorption measurements taken from the iron sensors having the covalently immobilized ferrozine that were applied to iron containing samples at salinity values of 15, 20, 25, 30 and 35, respectively. The absorption measurements recorded in FIG. 6B were taken from reacted iron sensors with covalently immobilized ferrozine with a POLARstar Omega multifunctional plate reader (BMG, Germany) using UV-VIS absorbance mode. The plots identified by 65a, 65b, 65c, and 65d in FIG. 6B are absorption measurements taken from the iron sensors with covalently immobilized ferrozine that were applied to iron containing samples at temperature values of 4° C., 10° C., 20° C., and 25° C., respectively. The results recorded in FIG. 6B illustrated that the iron sensor response was stable and constant when salinity of the iron containing solution varied from 15 to 35, or the temperature changed from 4° C. to 25° C. Thus no impacts from salinity and temperature were observed over these ranges.

Evaluation of the Effect Various Ions on the Performance of Iron Sensors Having Covalently Immobilized Ferrozine to Measure Iron (Fe²⁺) Concentrations

In order to evaluate the practical application of the Fe²⁺ sensor in the complex natural matrix of marine pore water, possible interferences from various foreign ions on sensor response to Fe²⁺ at pH 5.5 were studied. The concentration of each foreign ion listed in Table 1 is not the highest tolerance level of the Fe²⁺ measurement, but was chosen to be higher or similar to that in natural porewater. Interference from a foreign ion on the determination was considered to occur if the relative error was >5%. The salinity study and the results in Table 1 indicated that for the determination of 100 μM Fe²⁺, the major or minor ions, such as Na⁺, K⁺, Mg²⁺, Ca²⁺, Cl⁻, SO₄²⁻, CO₃²⁻, NO₃⁻, etc. do not interfere with determination of Fe²⁺.

TABLE 1
Effect of foreign ions on determination of 100 μM Fe²⁺ in solution.

| Foreign ion | Concentration (μM) | Relative error (%) |
|---|---|---|
| K⁺ | 10,000 | 2.02 |
| Ca²⁺ | 10,000 | 0.41 |
| Mg²⁺ | 50,000 | −2.54 |
| Mn²⁺ | 500 | 2.81 |
| Zn²⁺ | 1 | 3.86 |
| Cu²⁺ | 1 | 0.45 |
| Pb²⁺ | 1 | 3.23 |
| Al³⁺ | 1 | 2.03 |
| Fe³⁺ | 1 | 0.07 |
| Co²⁺ | 0.1 | 1.35 |
| Ni²⁺ | 0.1 | 4.76 |
| HCO₃⁻ | 2,000 | −4.31 |
| HPO₄²⁻ | 1,000 | −4.31 |
| NO₃⁻ | 10,000 | −0.83 |
| SO₄²⁻ | 25,000 | −2.33 |
| B(OH)₃⁻ | 500 | 3.93 |
| Br⁻ | 10,000 | 2.02% |
| ΣH₂S | 1,000 | 3.51% |

In addition, no interferences from minor or trace components such as Mn²⁺, Zn²⁺, Cu²⁺, Al³⁺, Co²⁺, Ni²⁺, Ni²⁺, Br⁻, ΣH₂S and B(OH)₃⁻ were observed even at concentrations in great excess compared to their level in natural porewater.

Accuracy of Iron Sensors Having Covalently Immobilized Ferrozine to Measure Iron (Fe²⁺) Concentrations

The accuracy of the sensor measurement was evaluated by testing the recovery of known amounts of Fe²⁺ added to seawater. The seawater was collected from Stony Brook Harbor with a salinity of approximately 27. The sample was filtered through 0.2 μm pore size polysulfone filters, acidified to a pH of 5, and then spiked with Fe²⁺, i.e., Fe²⁺ concentration increased, to the specified concentrations listed in the column titled “Spike Fe²⁺ (μM) in Table 2. The pH of Fe²⁺ spiked seawater samples was adjusted to pH of approximately 5, and an iron sensor with covalently immobilized ferrozine measured the dissolved iron (Fe²⁺) concentration. Each spiked seawater sample was measured three separate times. The measurement of iron (Fe²⁺) concentration using the iron sensor having the covalently immobilized ferrozine included inserting the iron sensor into the Fe²⁺ spiked seawater for a time period of 30 minutes, measuring absorbance of the iron sensor that reacted with the Fe²⁺ spiked seawater in a POLARstar Omega multifunctional plate reader (BMG, Germany) using UV-VIS absorbance mode, and correlating the absorbance of the iron sensor with the concentration of Fe²⁺ that was in the Fe²⁺ spiked seawater. The results of the concentration of Fe²⁺ measured from the Fe²⁺ spiked seawater using the iron sensor with covalently immobilized ferrozine was recorded in the column titled “Found (μM) (mean±SD)” in Table 2. The results in Table 2 showed that the recoveries of standard addition Fe²⁺ in seawater were in the range of 94.6%-103%. Agreement between the added and recovered amounts of Fe²⁺ in seawater indicated the consistency and accuracy of the measurements by the iron sensors with covalently immobilized ferrozine. Table 2 also shows that the relative standard deviations (RSD) were less 5% for all the sample measurements.

TABLE 2
The accuracy and precision of Fe²⁺ measurement in solution

| | Spike Fe²⁺ | Found (μM) | RSD | Recovery |
|---|---|---|---|---|
| Samples | (μM) | (mean ± SD) | (%) | (%) |
| Seawater* | 50.0 | 50.4 ± 2.3 | 4.6 | 100.8 |
| | 100.0 | 94.9 ± 2.6 | 2.7 | 94.9 |
| | 150.0 | 154.6 ± 3.5 | 2.3 | 103.0 |

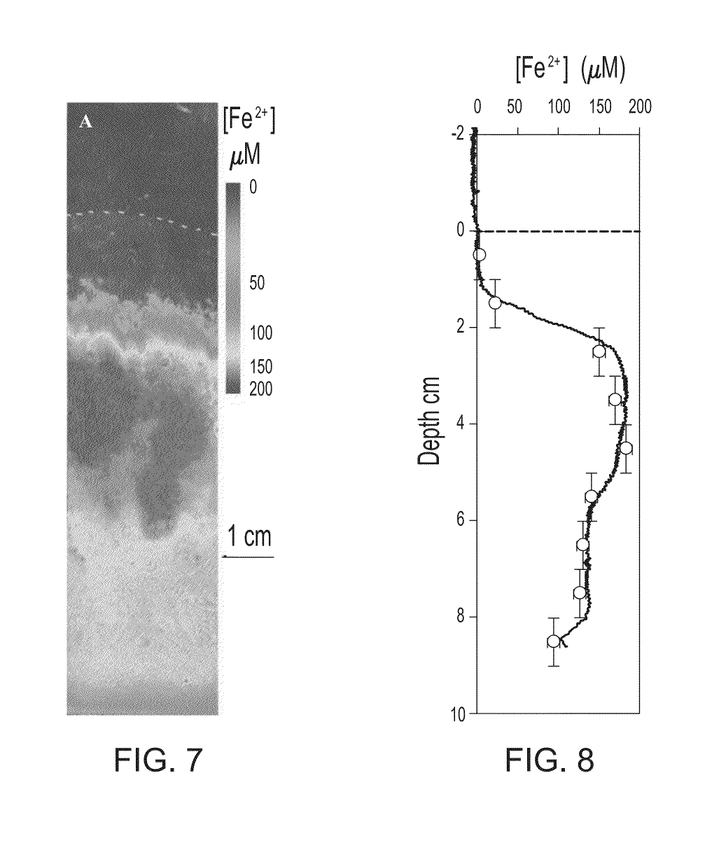

The accuracy of the iron sensor with covalently immobilized ferrozine also was also evaluated by comparing 2-dimensional Fe²⁺ distributions taken from homogenized marine sediment with the iron sensor with covalently immobilized ferrozine to an average Fe²⁺ profile that was obtained from the homogenized marine sediment by traditional ferrrozine spectrometric methods. The procedure for obtaining the Fe²⁺ distribution from the iron sensor having the covalently immobilized ferrozine is provided in the above section titled “Procedure for measurements of homogenized sediment containing Fe²⁺ with iron sensors with covalently immobilized ferrozine”. The 2-dimensional Fe²⁺ distributions measured from the homogenized marine sediment with the iron sensor with covalently immobilized ferrozine is depicted in FIG. 7. The dash line indicates the water-sediment interface.

The average Fe²⁺ profile that was obtained from the homogenized sediment using the procedures described above in the section titled “Procedure for comparative measurements of homogenized sediment containing Fe²⁺ with traditional methods”. FIG. 8 (open circle) depicts the average Fe²⁺ profile that was obtained from pore water separated from the homogenized sediment by a spectrophotometric method.

Comparison of FIGS. 7 and 8 indicates that the vertical Fe²⁺ profile (line in FIG. 8) averaged from the 2-dimensional image provided by the iron sensor with covalently immobilized ferrozine was consistent with data obtained by traditional core processing and analysis, such as spectrophotometric methods (open circle in FIG. 8). The data between 2-4 cm obtained by pore water extraction was slightly lower than predicted by the iron sensor with covalently immobilized ferrozine, implying that a small portion of dissolved Fe²⁺ may be lost during pore water extraction.

In the 2-dimensional Fe²⁺ distributions taken from homogenized marine sediment, the Fe²⁺ distribution pattern was close to being vertically stratified after 2 weeks of incubation at room temperature in the dark, as depicted in FIG. 7. The concentrations of dissolved Fe²⁺ in overlying water and in the oxic zone of the sediment were too low to be detected by the sensor (<5 μM), reflecting the rapid oxidation of Fe²⁺ near the interface region and presumably precipitation as ferric oxide. However, the concentration of dissolved Fe²⁺ increased sharply just below a depth of ˜1.5 cm in sediment where a sediment color change from light brown to black was visible. Below this boundary, Fe²⁺ concentration continually increased until a maximum formed at a depth of 3-5 cm. The decrease of Fe²⁺ below this depth presumably reflects precipitation of Fe-sulfides. Because the depth of oxygen penetration during the time when the sediment sample was taken was ˜0.2 mm-0.5 mm, the depletion of dissolved Fe²⁺ concentration in the upper 1.5 cm sediment layer implies oxidation of Fe²⁺ with oxidants such as MnO₂ and NO₃⁻ in the suboxic zone. Although the overall vertical patterns obtained by from the sensor profile and traditionally obtained pore water profile are quite comparable, the 2-dimensional Fe²⁺ distribution patterns reveal that a small degree of heterogeneity exists even in homogenized sediment, and because the concentration distributions are virtually continuous, the sensor distributions provide a basis for more accurate flux and reaction rate calculations relative to average concentrations over finite intervals.

Two-Dimensional Fe²⁺ Distribution Patterns Taken from Undisturbed Sediment Samples

Two-dimensional Fe²⁺ distribution patterns of various undisturbed (non-homogenized) sediment samples were obtained subtidally from central Long Island Sound were studied by using the iron sensor with covalently immobilized ferrozine.

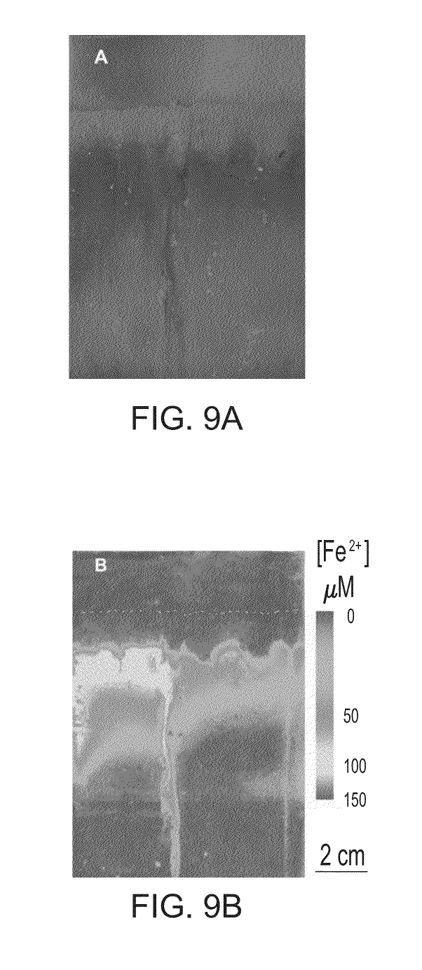

FIG. 9A is a visible image (green band) of a core sample of sediment with low dissolved sulfide taken from central Smithtown Bay, Long Island Sound, N.Y. (USA). The visible image depicted in FIG. 9A was provided from a core sample from Smithtown Bay following the procedures described in the above portion of this document titled,

Procedure for Fe²⁺ measurements from undisturbed intact sediment cores containing Fe²⁺ with iron sensors having covalently immobilized ferrozine”. FIG. 9A depicts pronounced heterogeneity in the natural sediment of the core sample. Visible physical features on the left side of the core appear nearly vertically stratified whereas the right side is obviously bioturbated and contains inhabited burrows. A closed, apparently abandoned, biogenic structure appeared in the middle and extended to the bottom of the core.

FIG. 9B is a two dimensional Fe²⁺ distribution pattern that was measured from the iron sensor that was in contact with the sediment sample that provided the visible image depicted in FIG. 9A. The two dimensional Fe²⁺ distribution pattern depicted in FIG. 9B was provided following the procedures described in the above portion of this document titled, “Procedure for Fe²⁺ measurements from undisturbed intact sediment cores containing Fe²⁺ with iron sensors having covalently immobilized ferrozine”. The dashed white line that is depicted in FIG. 9B is the water-sediment interface. The 2-dimensional Fe²⁺ concentration patterns depicted in FIG. 9B that correspond to the visual image depicted in FIG. 9A demonstrate substantial concentration variations within this single core and some of the factors causing them. The Fe²⁺ pattern is almost stratified on the left side, reflecting a dominant vertical pattern of surficial oxidized sediment with low Fe²⁺, a suboxic transition zone with maximum Fe²⁺ concentration, and an underlying zone of net Fe²⁺ loss due to formation of Fe-sulfides. Just a few centimeters away, on the right side of the core, the same overall concentration versus depth pattern occurs but with a muted and disjointed Fe²⁺ maximum zone associated with loss of Fe²⁺ around actively irrigated oxidized burrows. A high Fe²⁺ concentration (˜100 μM) zone was generated around the relict burrow structure in the middle of the core, demonstrating enhanced local reduction in the burrow wall after burrow abandonment. These local increases and decreases of dissolved Fe²⁺ and formation of insoluble Fe³⁺ oxides associated with abandoned or inhabited burrows create a complex, multi-dimensional dissolved and particulate iron distribution.

Dissolved sulfide is a factor influencing the distribution of Fe²⁺ in sediments, with Fe²⁺ varying inversely with respect to hydrogen sulfide concentration. For comparison with core samples from central Long Island Sound depicted in FIGS. 9A and 9B, where dissolved EH₂S is often greater than 20 μM in bioturbated surface regions, a sediment core was obtained from a mudflat in Flax Pond, Long Island, N.Y. (USA), where dissolved EH₂S typically ranges from 2 mM-7 mM in the upper ˜10 cm of the sediment.

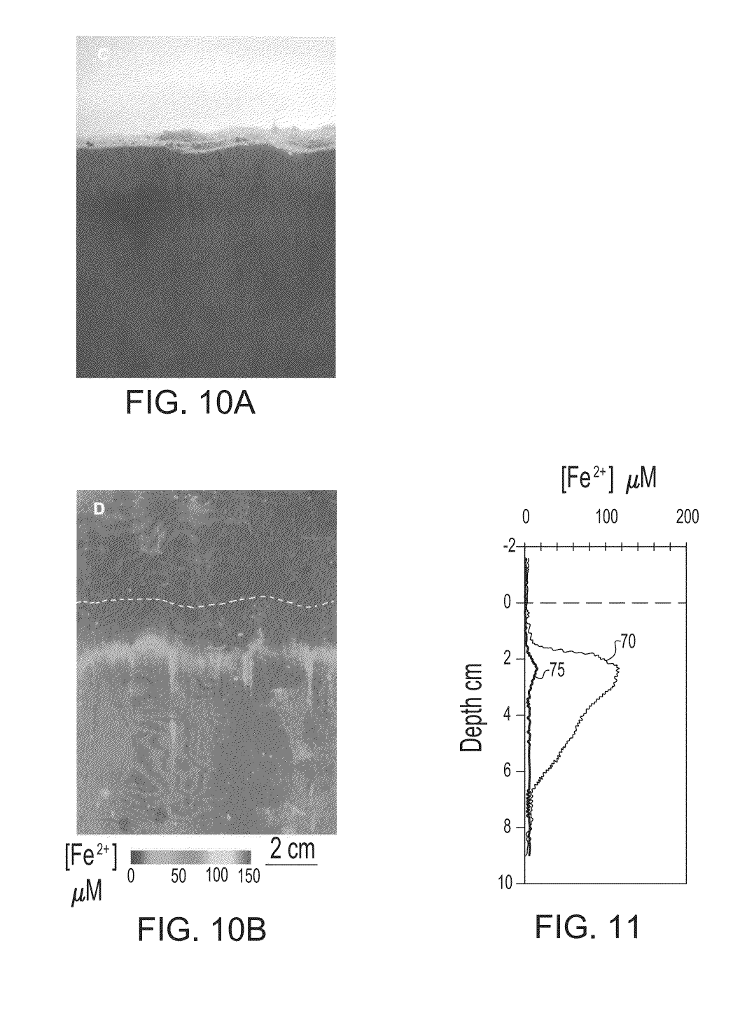

FIG. 10A is a visible image of a sediment box core retrieved following in-situ Fe²⁺ measurement in intertidal sediment with high dissolved sulfide taken from Flax Pond, Long Island, N.Y. (USA). The visible image depicted in FIG. 10A was provided from an in situ core sample from Flax Pond following the procedures described in the above portion of this document titled, “Procedure for in situ Fe²⁺ measurements from undisturbed intact sediment cores containing Fe²⁺ with iron sensors having covalently immobilized ferrozine”. FIG. 10B is a two dimensional Fe²⁺ distribution pattern that was measured from the iron sensor that was in contact with the sediment sample that provided the visible image depicted in FIG. 10A. The two dimensional Fe²⁺ distribution pattern depicted in FIG. 10B was provided following the procedures described in the above portion of this document titled, “Procedure for in situ Fe²⁺ measurements from undisturbed intact sediment cores containing Fe²⁺ with iron sensors having covalently immobilized ferrozine”.

The in-situ 2-dimensional Fe²⁺ distribution demonstrates a very thin Fe²⁺ band near the oxic—anoxic surface boundary and large regions where dissolved Fe²⁺ was undetectable (<4.5 μM). FIG. 11 is a plot of the average Fe²⁺ concentration in the maximum zone of the core samples that provided the two dimensional Fe²⁺ distribution patterns that are depicted in FIGS. 9B and 10B. Plot line 70 represents a vertical Fe²⁺ profile horizontally averaged from the 2-dimensional Fe²⁺ distribution pattern depicted in FIG. 9B, which was taken from a sediment core sample from Smithtown Bay, Long Island Sound, N.Y. (USA). Plot line 75 represents a Fe²⁺ profile horizontally averaged from the 2-dimensional Fe²⁺ distribution pattern depicted in FIG. 10B, which was taken from a core sample from Flax Pond, Long Island Sound, N.Y. (USA). The average Fe²⁺ concentration in the maximum zone was only about 10 μM in this high sulfide sediment from Flax Pond, Long Island, N.Y. (USA) versus the average Fe²⁺ concentration of 120-200 μM, as measured from Smithtown Bay, Long Island Sound, N.Y. (USA). Further, many high concentration microzones (hot spots) of Fe²⁺ were also observed in measurements from the sediment core taken from Flax Pond, Long Island, N.Y. (USA) revealing the spatial heterogeneity of elevated remineralization and localized microbial activity associated with various small biogenic structures or salt marsh detritus.

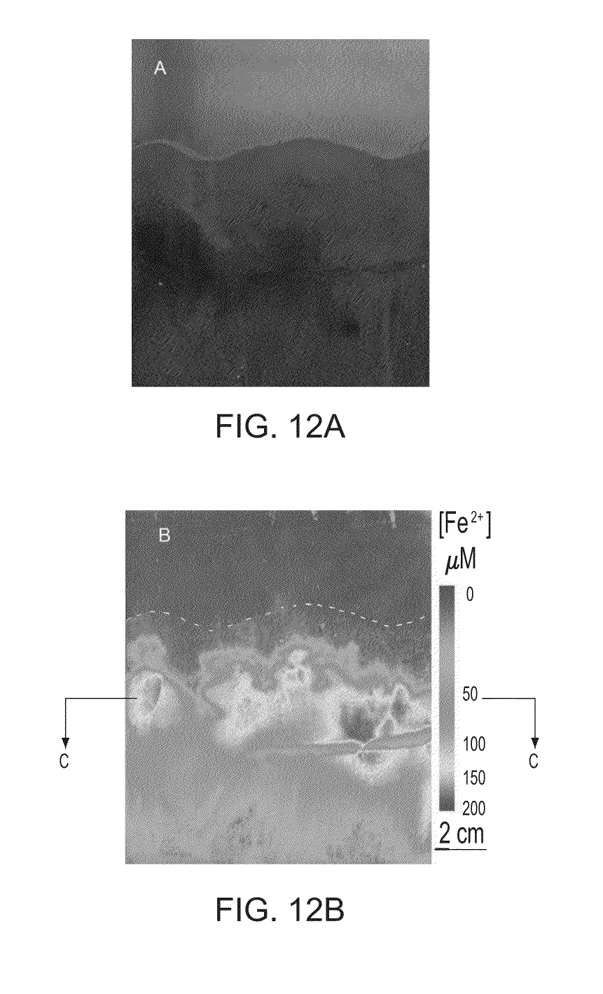

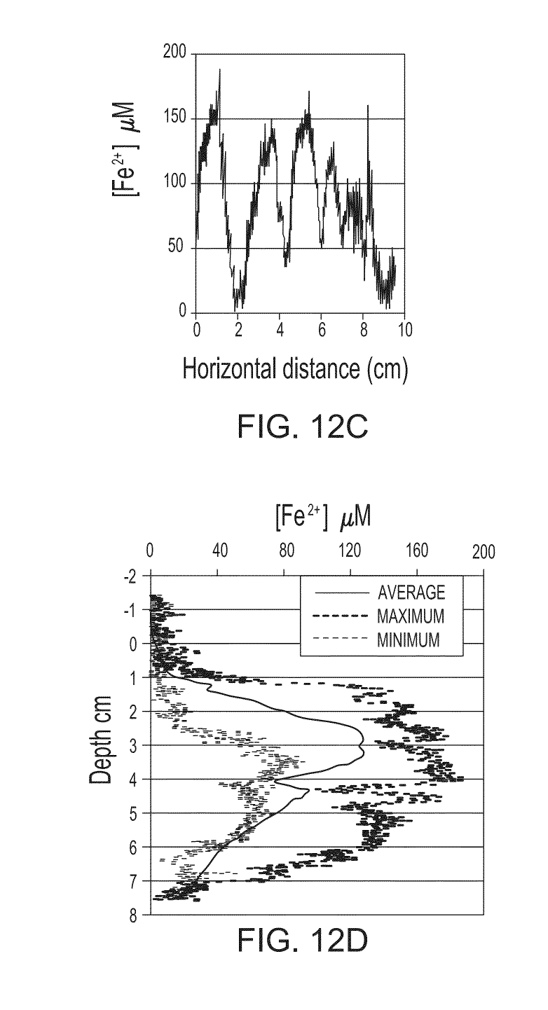

An example of spatially complex Fe²⁺ distributions around irrigated burrow structures was examined in more detail in an additional low dissolved sulfide core from Smithtown Bay, Long Island Sound, N.Y. (USA). FIGS. 12A-12D depict Fe²⁺ distribution in bioturbated marine sediment from Smithtown Bay, Long Island Sound, N.Y. (USA). The images and data depicted in FIGS. 12A-12D were generated using the procedures described above in the section of this paper titled “Procedure for Fe²⁺ measurements from undisturbed intact sediment cores containing Fe²⁺ with iron sensors having covalently immobilized ferrozine”.

FIG. 12A is a visible image of sediment profile, and FIG. 12B is a 2-dimensional Fe²⁺ distribution corresponding to visible image. FIG. 12C is a horizontal Fe²⁺ concentration profile extracted along the section line C-C in FIG. 12B. FIG. 12D is the horizontally averaged vertical Fe²⁺ profile of FIG. 12B indicating minimum (blue) and maximum Fe²⁺ concentration (red) within a given depth interval.

A horizontal transect at 2 cm depth showed oscillation of Fe²⁺ concentration between 0 and 150 μM associated with the specific spacing of burrow structures, as depicted in FIGS. 12B and 12C. The horizontally averaged vertical profiles from FIG. 12B indicated an 80-160 μM concentration range around the mean value in the maximum concentration zone, demonstrating the high variability within the maximum and the limitation of tradition methods for evaluating processes such as authigenic mineral formation and equilibria. In most cases, burrowing patterns are time dependent, and the three-dimensional Fe²⁺ distributions must change as infauna move and rework sediment. Unfortunately, the sensor developed in this work is a single 30 minute measurement and cannot be used to directly measure the dynamic changes of Fe²⁺ concentration necessarily associated with the irrigation activities and movements of individual infauna. Many of these temporal effects can be inferred, however, from multiple images of biogenic structures at different stages of development.

While the present disclosure has been particularly shown and described with respect to preferred embodiments thereof, it will be understood by those skilled in the art that the foregoing and other changes in forms and details may be made without departing from the spirit and scope of the present invention. It is therefore intended that the present invention not be limited to the exact forms and details described and illustrated, but fall within the scope of the appended claims.

What is claimed is:

1. A sensor for measuring iron concentration comprising:
a substrate;
a ferrozine containing reagent for detecting iron (Fe); and
a polymer covalently bonding the ferrozine containing reagent to the substrate.

2. The sensor of claim 1, wherein the ferrozine containing reagent is 3-(2-pyridyl)-5,6-diphenyl-1,2,4-triazine-p,p′-disulfonic acid monosodium salt hydrate.

3. The sensor of claim 1, wherein the substrate comprises a membrane of poly(vinyl alcohol), poly(vinyl chloride), D4 polyurethane hydrogel or ethyl cellulose.

4. The sensor of claim 3, wherein the membrane is comprised of poly(vinyl alcohol) and has a surface area ranging from 1 to 300 cm².

5. The sensor of claim 1, wherein the membrane has a thickness of 15 microns or less.

6. The sensor of claim 3, wherein the membrane is backed by a polyester sheet.

7. The sensor of claim 5, wherein a total thickness of the sensor ranges from 100 microns to 150 microns.

8. The sensor of claim 1, wherein the polymer bonding the ferrozine containing reagent comprises poly(N-isopropylacrylamide).

9. The sensor of claim 8, wherein the polymer bonding to the ferrozine containing reagent is to a sulfonate group of ferrozine.

10. The sensor of claim 1, wherein a concentration of ferrozine containing reagent that is present on the sensor ranges from 10 to 50 μg/cm².

11. A method of making a sensor for measuring iron concentration comprising:
reacting ferrozine (3-(2-pyridyl)-5,6-diphenyl-1,2,4-triazine-p,p′-disulfonic acid monosodium salt hydrate) with phosphorus pentachloride (PCl₅) to provide ferrozine sulfonyl chloride;
reacting ferrozine sulfonyl chloride with unsaturated alkyl amine to provide ferrozine sulfonamide; and
polymerizing a solution of the ferrozine sulfonamide and N-isopropylacrylamide on a poly(vinyl alcohol) membrane surface including at least one unsaturated alkyl bond to provide a ferrozine containing reagent that is covalently bonded to the poly(vinyl alcohol) membrane surface, wherein said ferrozine containing reagent reacts with iron (Fe) ions to form a ferrozine-Fe²⁺ complex.

12. The method of claim 11, wherein the poly(vinyl alcohol) membrane is provided by mixing poly(vinyl alcohol) in a water solution with glutaraldehyde (CH₂(CH₂CHO)₂), allylamine (C₃H₅NH₂), and hydrogen chloride (HCl).

13. The method of claim 11, wherein the ferrozine sulfonyl chloride is extracted with anhydrous acetone from the product of the ferrozine (3-(2-pyridyl)-5,6-diphenyl-1,2,4-triazine-p,p′-disulfonic acid monosodium salt hydrate) and phosphorus pentachloride (PCl₅) reaction.

14. The method of claim 11, wherein the unsaturated alkyl amine is at least one compound selected from the group consisting of allylamine, methallylamine, 4-aminostyrene and vinylaniline

15. The method of claim 11, wherein a polyester sheet provides back support for the poly(vinyl alcohol) membrane surface.

16. The method of claim 11, wherein the n-isopropylacryl amide is formed from monomer N-isoproplyacryl amide without crosslinker.

17. The method of claim 11, wherein the polymerizing is conducted in a nitrogen (N₂) atmosphere.

18. A method for measuring iron concentration comprising:
providing a sensor comprising a substrate, a ferrozine containing reagent, and a polymer covalently bonding the ferrozine containing reagent on the substrate;
inserting the sensor into a iron (Fe) containing sample, wherein the ferrozine containing reagant reacts with iron (Fe) ions in the iron (Fe) containing sample; and
measuring the optical properties of the sensor after the ferrozine containing reagent reacts with the iron (Fe) ions in the iron (Fe) containing sample to determine the concentration of the iron (Fe) ions in the iron (Fe) containing sample.

19. The method of claim 18, wherein the substrate comprises a membrane of poly(vinyl alcohol).

20. The method of claim 19, wherein the polymer covalently bonding the ferrozine containing reagent to the membrane of poly(vinyl alcohol) is through sulfonate groups of the ferrozine containing reagent.

21. The method of claim 19, wherein the inserting of the sensor into the iron (Fe) containing sample comprises formation of a ferrozine-Fe²⁺ complex on the membrane.

22. The method of claim 18, wherein the iron (Fe) containing sample has a pH ranging from 3.5 to 10.5.

23. The method of claim 18, wherein the iron (Fe) containing sample comprises a liquid solution of iron (Fe) ions, sediment containing iron (Fe) or a combination thereof.

24. The method of claim 19, wherein the measuring the optical properties of the sensor comprises comparison to color chart, flatbed optical scanner or hand held scanner.

25. The method of claim 24, wherein the measuring of the optical properties of the sensor to determine the concentration of the iron (Fe) ions in the iron (Fe) containing sample comprises measuring an absorbance of a wavelength through the sensor and correlating the absorbance to a concentration of iron (Fe) ions in the ferrozine-Fe²⁺ complex on the membrane of the sensor.

26. The method of claim 25, wherein the correlating of the absorbance to the concentration of iron (Fe) ions is through Beer-Lambert law.

27. The method of claim 25, wherein there is a linear correlation between absorbance and the concentration of iron (Fe) ions in the ferrozine-Fe²⁺ complex on the membrane, wherein as the absorbance measured increases, the concentration of iron (Fe) ions in the ferrozine-Fe²⁺ complex increases.

28. The method of claim 25, wherein the sensor having the ferrozine-Fe²⁺ complex on the membrane has a maximum absorbance wavelength ranging from 550 nm to 570 nm.

29. The method of claim 28, wherein the concentration of the iron (Fe) ions in the ferrous oxide containing sample measured by the sensor is as great as 250 μM.

30. The method of claim 29, wherein the minimum concentration of iron (Fe) ions measured by the sensor is 4.5 μM.
